(19) United States
(12) Patent Application Publication
(10) Pub. No.: US 2016/0061168 A1
(43) Pub. Date: Mar. 3, 2016

(54) Single Actuator Fuel Injector for Duel Fuels

(71) Applicant: Caterpillar Inc., Peoria, IL (US)

(72) Inventor: Dana R. Coldren, Secor, IL (US)

(73) Assignee: Caterpillar Inc., Peoria, IL (US)

(21) Appl. No.: 14/476,344

(22) Filed: Sep. 3, 2014

(51) Int. Cl. F02M 43/04; F02M 63/00

(52) U.S. Cl. CPC F02M 43/04; F02M 63/0031

(57) ABSTRACT

A fuel injector concurrently injects a liquid fuel and a gaseous fuel into a combustion chamber of an internal combustion engine. An interior wall of an injector body defines a control chamber and an injection chamber. A needle valve is disposed within the body and has a control surface fluidly communicating with the control chamber. A liquid fuel inlet fluidly communicates with the control chamber and a gaseous fuel inlet fluidly communicates with the injection chamber. A delivery passage is defined by at least one of the needle valve and the interior wall and configured to place the control chamber in fluid communication with the injection chamber to permit flow of liquid fuel therebetween.

### TECHNICAL FIELD

This disclosure relates to an apparatus and method for delivering two fuels to a direct injection internal combustion engine. More specifically, this disclosure relates to a fuel injector with a single actuator that can deliver a liquid and a gaseous fuel through an outlet nozzle to a combustion chamber.

### BACKGROUND

Compression ignition engines, such as diesel engines, introduce fuel directly into the combustion chamber. Such engines are very efficient because they provide high compression ratios without knocking, which is the premature detonation of the fuel mixture inside the combustion chamber. Because diesel engines introduce fuel directly into the combustion chamber, the fuel injection pressure must be greater than the pressure inside the combustion chamber. For liquid fuels such as diesel, the pressure must be significantly higher so that the fuel is atomized for efficient combustion.

Diesel engines are favored by industry because of their excellent combination of power, performance, efficiency and reliability. For example, diesel engines are generally much less expensive to operate compared to gasoline fueled, spark-ignited engines, especially in commercial applications where large quantities of fuel are used. However, one disadvantage of diesel engines is pollution, such as particulate matter (soot) and NOx gases, which are subject to increasingly stringent regulations that require NOx emissions to be progressively reduced over time. To comply with these increasingly stringent regulations, engine manufacturers are developing catalytic converters and other aftertreatment devices to remove pollutants from diesel exhaust streams.

Improvements to diesel fuels are also being introduced to reduce the amount of sulfur in diesel fuel, to prevent sulfur from de-activating the catalysts of catalytic converters and to reduce air pollution. Research is also being conducted to improve combustion efficiency to reduce engine emissions, for example by making refinements to engine control strategies. However, most of these approaches add to the capital cost of the engine and/or the operating costs.

Other recent developments have been directed to substituting some of the diesel fuel with cleaner burning gaseous fuels such as, for example, natural gas, pure methane, butane, propane, hydrogen, and blends thereof. Since gaseous fuels typically do not auto-ignite at the same temperature and pressure as diesel fuel, a small amount of pilot diesel fuel can be introduced into the combustion chamber to auto-ignite and trigger the ignition of the gaseous fuel. Another approach for consuming gaseous fuel on board a vehicle involves introducing the gaseous fuel into the engine's intake air manifold at relatively low pressures. However, this approach has been unable to match the performance and efficiency of currently available diesel engines, particularly at high gas-diesel ratios. Thus, the simultaneous delivery of both diesel fuel and gaseous fuel to combustion chambers, with the diesel acting as a pilot fuel, is desirable.

One problem associated with delivering two different fuels for injection directly into the combustion chambers of an internal combustion engine is the lack of physical space for two fuel injectors per cylinder and space near the fuel injectors to provide two fuel rails in addition to drain lines for taking away fuel that may leak from the injectors. The need for two actuators per cylinder adds to the space problem. While some fuel injectors have been proposed that are capable of injecting two different fuels, these dual fuel injectors are overly complex and expensive to build.

### SUMMARY OF THE DISCLOSURE

In accordance with one aspect of the disclosure, a fuel injector is provided for concurrently injecting a liquid fuel and a gaseous fuel into a combustion chamber of an internal combustion engine. The fuel injector may include an injector body having an interior wall defining a cavity, the cavity including a control chamber and an injection chamber, the injection chamber fluidly communicating with an outlet nozzle, and a valve seat disposed between the injection chamber and the outlet nozzle. A needle valve may be disposed in the cavity and have a closing surface configured to sealingly engage the valve seat when the needle valve is in a closed position, the needle valve further having a control surface fluidly communicating with the control chamber. The injector body may define a liquid fuel inlet that fluidly communicates with the control chamber through a liquid fuel passage. A gaseous fuel inlet may be defined by the injector body and fluidly communicate with the injection chamber through a gaseous fuel passage, and a delivery passage may be defined by at least one of the needle valve and the interior wall and configured to place the control chamber in fluid communication with the injection chamber, the delivery passage having a cross-sectional area sufficient to permit flow of the liquid fuel.

In another aspect of the disclosure that may be combined with any of these aspects, a method of operating a fuel injector is provided for concurrently injecting a liquid fuel and a gaseous fuel, the fuel injector including a single needle valve disposed in a fuel injector body. The method may include supplying a liquid fuel to the fuel injector at a first pressure, supplying a gaseous fuel to an injection chamber of the fuel injector at a second pressure, the second pressure being less than the first pressure, and directing the liquid fuel to a control chamber operatively coupled to the single needle valve. Liquid fuel may be migrated from the control chamber to the injection chamber through a delivery passage defined by at least one of the needle valve and the fuel injector body, and an amount of liquid fuel migration may be controlled by adjusting the first pressure.

In another aspect of the disclosure that may be combined with any of these aspects, a fuel injector may be provided for concurrently injecting a liquid fuel and a gaseous fuel into a combustion chamber of an internal combustion engine. The fuel injector may include an injector body having an interior wall defining a control chamber and an injection chamber, the injection chamber fluidly communicating with an outlet nozzle, and a valve seat disposed between the injection chamber and the outlet nozzle, the interior wall further including a guide portion disposed between the control chamber and the injection chamber. The injector may further include a needle valve disposed within the injector body interior wall and having a closing surface configured to sealingly engage the valve seat when the needle valve is in a closed position, the needle valve further having a control surface fluidly communicating with the control chamber and a stem portion disposed between the control surface and the closing surface. A liquid fuel inlet may be defined by the injector body and fluidly communicate with the control chamber through a liquid fuel passage, and a control valve may be disposed in the liquid fuel passage. A gaseous fuel inlet may be defined by the injector body and fluidly communicate with the injection chamber through a gaseous fuel passage, and a gaseous fuel check valve may be disposed in the gaseous fuel passage. The fuel injector may further include a delivery passage defined by at least one of the needle valve stem portion and the interior wall guide portion and configured to place the control chamber in fluid communication with the injection chamber, the delivery passage having a cross-sectional area sufficient to permit flow of the liquid fuel.

In another aspect of the disclosure that may be combined with any of these aspects, the delivery passage may comprise a clearance space formed between the needle valve and the interior wall.

In another aspect of the disclosure that may be combined with any of these aspects, the interior wall may include a guide portion disposed between the control chamber and the injection chamber, and the needle valve may include a stem portion disposed between the control surface and the closing surface, the needle valve stem portion being sized relative to the interior wall guide portion to define the clearance space.

In another aspect of the disclosure that may be combined with any of these aspects, the needle valve stem portion may be cylindrical and define a first diameter, and the interior wall guide portion may be cylindrical and define a second diameter larger than the first diameter.

In another aspect of the disclosure that may be combined with any of these aspects, the second diameter may be at least 3 microns larger than the first diameter.

In another aspect of the disclosure that may be combined with any of these aspects, the delivery passage may comprise a groove formed in at least one of the needle valve and the interior wall.

In another aspect of the disclosure that may be combined with any of these aspects, the delivery passage may comprise a conduit extending through the needle valve.

In another aspect of the disclosure that may be combined with any of these aspects, a three-way control valve may be disposed in the liquid fuel passage.

### BRIEF DESCRIPTION OF THE DRAWINGS

FIG. 1 is a partial sectional and schematic view of a fuel injector with a liquid fuel control valve in a first closed or lower position and a needle valve in a closed or non-injecting position.

FIG. 2 is a partial sectional and schematic view of the fuel injector disclosed in FIG. 1, but with the liquid fuel control valve in a second closed or upper position and the needle valve in an open or injecting position.

FIG. 3 is a partial sectional view of another embodiment of a fuel injector with the liquid fuel control valve in a first closed or lower position and having a bypass passage that links the liquid fuel source with the gaseous fuel source for use when the gaseous fuel source supply is interrupted or is supplied at an insufficient pressure.

FIG. 4 is a partial sectional view of the fuel injector shown in FIG. 3 with the liquid fuel control valve in an open position.

FIG. 5 is an enlarged detail view of an exemplary needle valve and a fuel injector body that may be incorporated into the fuel injectors disclosed herein.

FIG. 6 is an enlarged detail view of an exemplary outlet nozzle that may be incorporated into the fuel injectors disclosed herein.

### DETAILED DESCRIPTION

In this disclosure “gaseous fuel” is broadly defined as any combustible fuel that is in the gaseous phase at atmospheric pressure and ambient temperature.

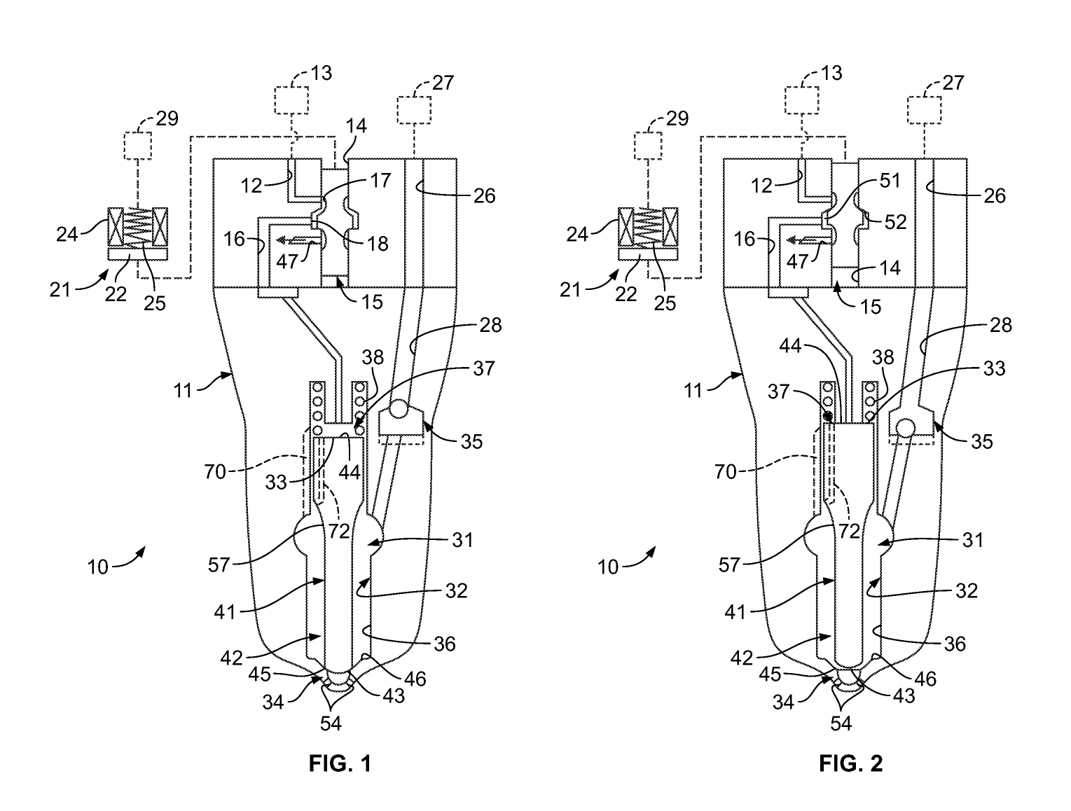

Referring now to FIG. 1, an electronically actuated fuel injector 10 includes a fuel injector body 11 that contains various moving components positioned as they would be prior to initiation of an injection event. The body 11 includes a liquid fuel inlet 12 that receives liquid fuel from a liquid fuel supply 13, such as a fuel rail, that may also include a pump (not shown) for delivering the liquid fuel to the liquid fuel inlet 12 at a predetermined pressure. For example, the liquid fuel, which may be diesel fuel, may be delivered through the liquid fuel inlet 12 at a pressure of about 40 MPa (5,802 psi), although the inlet pressure for the liquid fuel may vary widely, e.g., from about 30 MPa (4,341 psi) to about 50 MPa (7,252 psi). Thus, the liquid fuel supply 13 may include a reservoir (not shown) as well as a pump (not shown) or other means for delivering the liquid fuel to the liquid fuel inlet 12 at a desired pressure.

The fuel injector body 11 also includes a liquid fuel control valve cavity 14 which accommodates a liquid fuel control valve 15. In the embodiments illustrated herein, the liquid fuel control valve 15 is shown as a three-way valve, however an alternative type of control valve, such as a two way valve, may be used. The liquid fuel control valve 15 is shown in an open position in FIG. 1 whereby communication between the liquid fuel inlet 12 and the liquid fuel passage 16 is provided by way of the annulus 17 disposed in the liquid fuel control valve 15 and the annulus 18 disposed in the injector body 11. The liquid fuel control valve 15 may be coupled to a solenoid assembly 21 which may, for example, may include an armature 22, a coil 24 and a spring 25, which an electrical supply 29 operatively coupled to the solenoid assembly 21. With the coil 24 deactivated (i.e., no current is supplied to the solenoid assembly 21), a pre-load force of the spring 25 may bias the liquid fuel control valve 15 downward into a lower or first closed position shown in FIG. 1, during which the injector may be loaded with fuel but does not discharge fuel in an injection event. The spring pre-load force may be sufficient to drive the liquid fuel control valve 15 into sealing engagement with the surrounding structure. When current is supplied to the solenoid assembly to activate the coil 24, the coil 24 generates sufficient force to move the armature 22 upward against the pre-load force of the spring 25, which also pulls the liquid fuel control valve 15 upward to an upper or second closed position shown in FIG. 2, during which fuel loading of the injector is prevented but the injector may discharge fuel in an injection event.

Returning to FIG. 1, the injector body 11 may also include a gaseous fuel inlet 26 which receives gaseous fuel from the gaseous fuel supply 27. The gaseous fuel supply 27 may be a pressurized supply or reservoir of gaseous fuel, which may be in a liquid or supercritical state, and which may also include a pump (not shown) for delivering the gaseous fuel to the gaseous fuel inlet at a desired pressure. In an embodiment, the gaseous fuel is delivered to the gaseous fuel inlet 26 at a lower pressure than the liquid fuel is delivered to the liquid fuel inlet 12. One exemplary pressure for the gaseous fuel is about 35 MPa (5,076 psi), but the gaseous fuel inlet 26 pressure may vary from about 15 MPa (2,176 psi) to about 45 MPa (6,527 psi). The gaseous fuel inlet 26 fluidly communicates with a gaseous fuel passage 28 that may include a gaseous fuel check valve 35.

The injector body 11 includes an interior wall 36 defining a needle valve cavity 32. In the illustrated embodiment, the cavity 32 may define different portions for performing specific functions. For example, a distal portion 42 of the cavity 32 may define an injection chamber 31 that fluidly communicates with an outlet nozzle 34. The outlet nozzle 34 may be disposed in or otherwise fluidly communicate with an interior of the engine combustion chamber (not shown). A valve seat 46 may be disposed between the injection chamber 31 and the outlet nozzle 34. A proximal portion of the cavity 32 may define a control chamber 37.

A needle valve 41 is disposed in the cavity 32 to control when fuel is discharged through the outlet nozzle 34. A distal end 43 of the needle valve 41 may be formed with a closing surface 45 configured to sealingly engage the valve seat 46 when the needle valve 41 is in a closed position, as shown in FIG. 1. In the closed position, the needle valve 41 isolates the outlet nozzle 34 from the liquid and gaseous fuels disposed in the injection chamber 31 prior to an injection event. In an open position shown in FIG. 2, the closing surface 45 is spaced from the valve seat 46 so that the injection chamber 31 fluidly communicates with the outlet nozzle 34. The needle valve 41 may also include a control surface 33 that fluidly communicates with the control chamber 37. In the illustrated embodiment, the control surface 33 is positioned at the extreme proximal end 44 of the needle valve 41, however the control surface 33 may be located at other positions along the needle valve 41 as it remains operatively coupled to the control chamber 37.

A delivery passage is defined by at least one of the needle valve 41 and the body interior wall 36 to allow liquid fuel in the control chamber 37 to migrate to the injection chamber 31. The delivery passage may take any one of several forms, as long as it is configured to place the control chamber 37 in fluid communication with the injection chamber 31 and has a cross-sectional area sufficient to permit flow of the liquid fuel. The delivery passage may be a feature formed by or in the needle valve 41 or the body interior wall 36, or a combination features formed in both the needle valve 41 and the body interior wall 36.

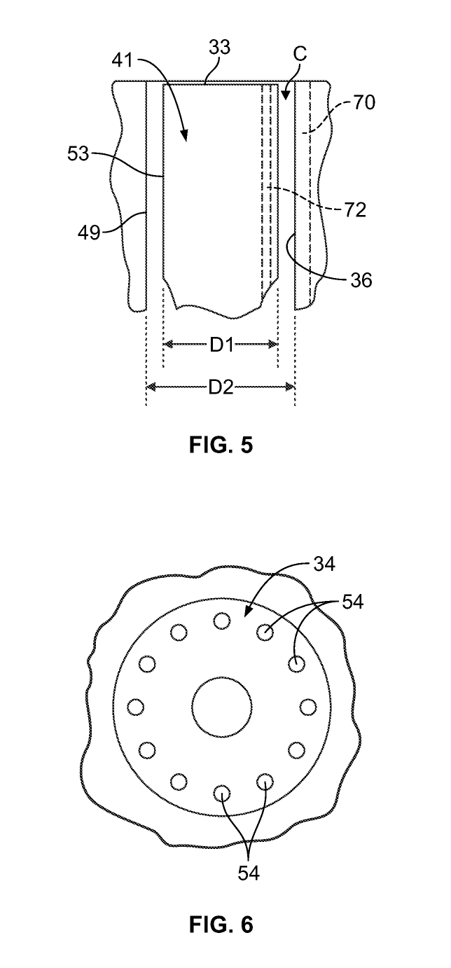

In an exemplary embodiment, the delivery passage may be a clearance space C provided between the needle valve 41 and the body interior wall 36. As best shown in FIG. 5, the interior wall 36 may include a guide portion 49 located between the control chamber 37 and the injection chamber 31, while the needle valve 41 may include a stem portion 53 located between the control surface 33 and the closing surface 45. The stem portion 53 may be sized relative to the guide portion 49 to define the clearance space C, thereby to permit liquid fuel to migrate therethrough. In the exemplary embodiment, the stem portion 53 is cylindrical and defines a first diameter D1, while the guide portion 49 is also cylindrical and defines a second diameter D2 that is greater than the first diameter D1. The diameters may be selected so that the clearance space C has a cross-sectional area sufficient to permit a desired flow rate of liquid fuel to the injection chamber 31. According to some embodiments, the second diameter D2 may be at least three microns larger than the first diameter D1. In other embodiments, the second diameter D2 is approximately four to ten microns larger than the first diameter D1.

In an alternative embodiment, the delivery passage may be provided by one or more grooves formed in at least one of the needle valve 41 and the body interior wall 36. An exemplary groove 70 is shown in phantom lines in FIGS. 1-5 formed in the body interior wall 36 and extending from the control chamber 37 to the injection chamber 31. In an alternative embodiment not shown, the groove may be formed in the needle valve 41. Still further, both the body interior wall 36 and the needle valve 41 may be formed with grooves and/or groove portions. Additionally, more than one groove may be formed in the body interior wall 36, the needle valve 41, or both.

In yet another alternative embodiment, the delivery passage may be provided by a conduit 72 extending through the needle valve 41, as also shown in phantom lines in FIGS. 1-5. The conduit 72 may be offset from an axis of the needle valve 4l so that it does not fluidly communicate with the liquid fuel passage 16 when the needle valve is in the open position (FIGS. 2 and 4). The conduit 72 may extend from the proximal end 44 of the needle valve 41 to an intermediate portion of the needle valve 41 that fluidly communicates with the injection chamber 31.

Because the liquid fuel may be introduced into the injection chamber 31 at an extended distance from the outlet nozzle 34, the outlet nozzle 34 may be configured to promote dispersion of the liquid fuel as it is discharged to better insure that the liquid fuel will ignite in the combustion chamber. In some embodiments, the outlet nozzle 34 may have in excess of 10 outlet apertures 54, such as twelve outlet apertures 54 as shown in FIG. 6, to promote sufficient dispersion of the liquid fuel.

With the liquid fuel control valve 15 in the lower position shown in FIG. 1, liquid fuel is communicated through the liquid fuel passage 16 to the control chamber 37. The control chamber 37 may also include a biasing spring 38. Pressure provided to the control chamber 37 by way of the pressurized liquid fuel passing through the liquid fuel passage 16 in combination with the biasing force of the biasing spring 38 may bias the needle valve 41 towards the closed position, as also shown in FIG. 1.

Referring to FIG. 2, current has been supplied to the solenoid assembly 21 to move the liquid fuel control valve 15 to an upper position. In the upper position, the sealing surface 51 of the liquid fuel control valve 15 engages the conical valve seat 52 of the liquid fuel control valve cavity 14 thereby shutting off flow between the liquid fuel inlet 12 and the liquid fuel passage 16.

For an injection event, the liquid and gaseous fuels may be supplied to the needle valve cavity 32 in the following manner. First, with the liquid fuel control valve 15 in the lower position (as shown in FIG. 1), liquid fuel is supplied through the liquid fuel inlet 12 via the liquid fuel supply 13. Liquid fuel proceeds through the liquid fuel inlet 12, past the liquid fuel control valve 15 and into the liquid fuel passage 16. At this point, the liquid fuel is pressurized, with one exemplary pressure being about 40 MPa. The pressurized liquid fuel continues down the liquid fuel passage 16 into the control chamber 37. The pressurized fuel in the control chamber 37, in combination with the biasing spring 38, maintains the needle valve 41 in the closed position as shown in FIG. 1. The pressurized liquid fuel may further migrate from the control chamber 37 to the injection chamber 31 through the delivery passage. Pressure in the injection chamber 31 may increase and force the gaseous fuel check valve 35 to a closed position. To ensure that the gaseous fuel check valve 35 closes in these conditions, a bias close spring may be operably coupled to the gaseous fuel check valve 35. Liquid fuel may continue to enter the injection chamber 31 until it reaches a static pressure balance with any gas remaining in the injection chamber 31 after the previous injection event.

For a given cross-sectional area of the delivery passage and a given period between injection events, the amount of liquid fuel delivered to the cavity 32 may be manipulated by manipulating the pressure differential between the liquid and gaseous fuels. Specifically, if ΔP equals the pressure of the liquid fuel P_{L} minus the pressure of the gaseous fuel P_{G}, increasing ΔP increases the amount of liquid fuel delivered to the cavity 32 and decreasing ΔP decreases the amount of liquid fuel delivered to the cavity 32. In some embodiments, ΔP may be at least five MPa. In other embodiments, ΔP may be approximately 5-20 MPa.

After the injection chamber 31 is charged with liquid fuel, current is supplied to the solenoid assembly 21 and the liquid fuel control valve 15 is moved upwards to the gas-loading position, as discussed above and as shown in FIG. 2. With the liquid fuel control valve 15 in this position, pressure in the liquid fuel passage 16 is reduced through exposure to the drain 47 as shown in FIG. 2. As pressure in the control chamber 37 is reduced by the drain 47, the needle valve 41 opens, which further reduces pressure in injection chamber 31 and which opens the gaseous fuel check valve 35. Gaseous fuel proceeds through the passage 28, past the check valve 35 and into the injection chamber 31 as the injection event begins.

As current continues to flow through the coil 24, the liquid fuel control valve 15 is maintained in the gas-loading position shown in FIG. 2 and gaseous fuel continues to enter the injection chamber 31, while the continued exposure of the liquid fuel passage 16 to the drain 47 reduces the pressure in the control chamber 37. With pressure in the control chamber 37 reduced, gaseous fuel disposed in the injection chamber 31 acts on a lifting hydraulic surface 57 of the needle valve 41, thereby causing the needle valve 41 to move upward against the bias of the spring 38 to open the needle valve 41 for an injection event. At this point, the gaseous fuel check valve 35 is opened and the pressurized liquid and gaseous fuels in the injection chamber 31 exit the fuel injector 10 via the outlet apertures 54.

The amount of gaseous fuel delivered to the cylinder during an injection event may be manipulated by controlling the duration of the time that the solenoid assembly 21 is energized. Increasing the time the coil 24 is energized increases the amount of gaseous fuel delivered during an injection event; decreasing the time the coil 24 is energized decreases the amount of gas delivered during an injection event.

An injection event is stopped when the coil 24 is de-energized so that the spring 25 forces the liquid fuel control valve 15 back to the lower position shown in FIG. 1. Pressure builds in the control chamber 37 which, in combination with the spring 38, closes the needle valve 41. As liquid fuel is recharged into the injection chamber 31, the fluid pressure in the injection chamber 31 again builds to the diesel rail pressure and the gaseous fuel check valve 35 closes. Liquid and gaseous fuels are sequentially re-supplied to the injection chamber 31 as described above.

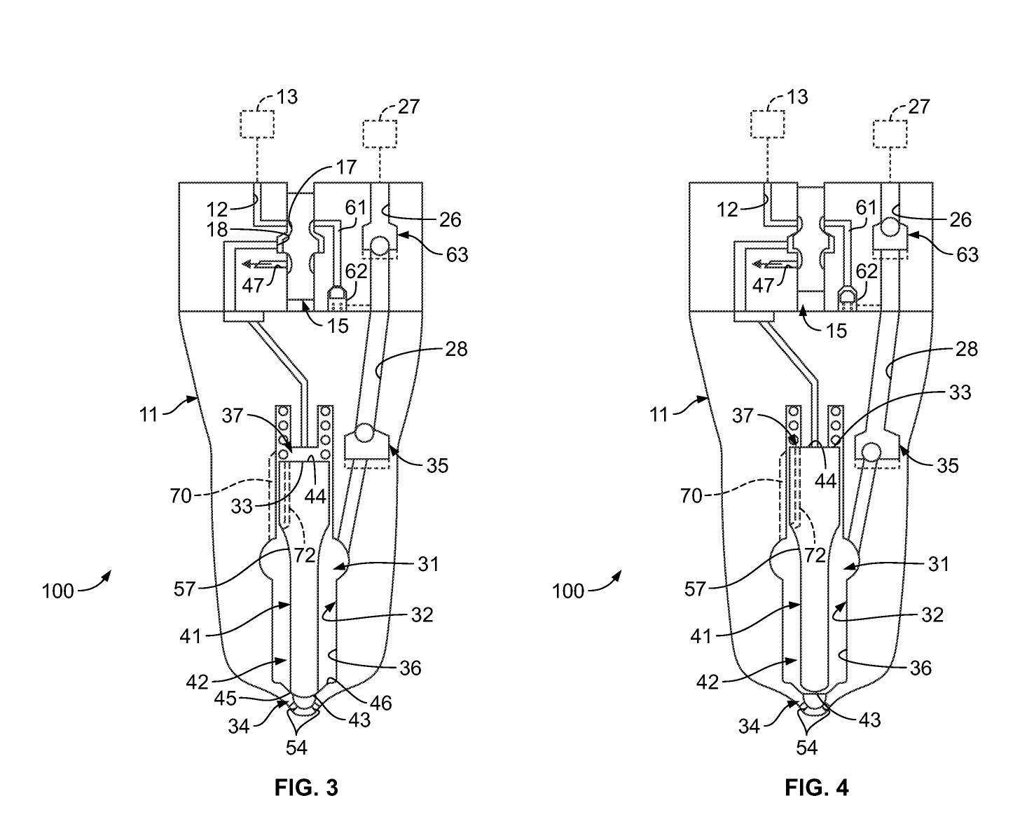

Turning to FIGS. 3 and 4, a fuel injector 100 is shown with a liquid fuel bypass passage 61. The bypass passage 61 supplies liquid fuel to the gaseous fuel passage 28 when the supply of gaseous fuel is interrupted or depleted or if the gaseous fuel supply experiences low pressure, which may be the case in the event of a cold weather start. In the embodiment shown in FIGS. 3 and 4, liquid fuel is used as a substitute for the depleted gaseous fuel, which enables the operator to get the equipment back to the home base or to a gaseous fuel supply station.

The liquid fuel bypass passage 61 includes a bypass check valve 62 that remains closed as long as there is pressure in the gaseous fuel passage 28. The bypass check valve 62 may be a pressure-imbalanced valve configured to have a net positive upward force to allow higher liquid fuel flow when no gas fuel pressure is present. The gaseous fuel passage 28 is equipped with an additional check valve 63. Similar to the check valve 35, a bias close spring may be operably coupled to the check valve 63 to ensure that it closes in the desired conditions. When the supply 27 of gaseous fuel is interrupted or the gaseous fuel supply 27 becomes depleted, pressure in the gaseous fuel passages 26, 28 will drop causing the bypass check valve 62 to open as shown in FIG. 4. In the open position shown in FIG. 4, with the liquid fuel control valve 15 moved to the upper position, the liquid fuel inlet 12 is in communication with the liquid fuel bypass passage 61 thereby supplying liquid fuel to the passage 28. The presence of the pressurized liquid fuel in the passage 28 moves check valve 63 to the upper position to prevent liquid fuel from back filling into the supply 27 of gaseous fuel. Additionally, the check valve 35 opens to permit liquid fuel to enter the injection chamber 31 of the needle valve cavity 32. Thus, even if the supply of gaseous fuel is interrupted, a sufficient amount of liquid fuel is supplied through both passages 28 and 16 for a suitable injection event. Again, the fuel injector 100 of FIGS. 3-4 is useful for cold starting conditions where the pressure of the gaseous fuel may be low or in situations where the gaseous fuel supply is depleted and the liquid fuel (e.g. diesel) is needed to transport the vehicle back to the home base or to a gaseous fuel supply station.

### INDUSTRIAL APPLICABILITY

Improved fuel injectors are disclosed that are capable of simultaneously delivering liquid and gaseous fuels to the combustion chamber of a compression ignition engine. For example, fuel injectors are disclosed that can deliver liquid diesel fuel, as a pilot liquid, along with a gaseous fuel, such as natural gas or other available fuels that are gases at atmospheric pressure and ambient temperature. The gaseous fuel may be delivered directly to the injection chamber, while the liquid fuel is delivered to a control chamber used to actuate the needle valve. A delivery passage defined by at least one of the needle valve and the fuel injector body places the injection chamber in fluid communication with the control chamber. The liquid fuel is maintained at a higher pressure than the gaseous fuel so that liquid fuel will migrate through the delivery passage from the control chamber to the injection chamber.

Accordingly, a method of operating a fuel injector is provided for concurrently injecting a liquid fuel and a gaseous fuel, where the fuel injector includes a single needle valve within a fuel injector body. The method includes supplying a liquid fuel to the fuel injector at a first pressure and supplying a gaseous fuel to an injection chamber of the fuel injector at a second pressure, the second pressure being less than the first pressure. The liquid fuel is directed to a control chamber operatively coupled to the single needle valve, and migrates from the control chamber to the injection chamber through a delivery passage formed between the needle valve and the fuel injector body. The amount of liquid fuel migration is controlled by adjusting the first pressure. In some embodiments, the first pressure is controlled to be at least 5 MPa higher than the second pressure. In other embodiments, the first pressure is controlled to be approximately 5-20 MPa higher than the second pressure.

The disclosed fuel injectors deliver both liquid and gaseous fuels to a combustion chamber using a single actuator. The disclosed designs are simple and include a reduced number of parts as compared to competing designs, resulting in reduced costs and improved packaging. For example, the delivery passage eliminates the need for a separate passageway between the liquid fuel inlet and the injection chamber.

The quantity of liquid pilot fuel migrating to the injection chamber may be proportional to the pressure differential between the liquid fuel pressure (which may be approximately 40 MPa, for example) and the gaseous fuel pressure (which may be approximately 25 MPa, for example). The rate of migration, therefore, may be changed by adjusting a pressure differential “ΔP” between the two fuels. As the pressure differential increases, the migration rate of liquid fuel increases. Conversely, as the pressure differential decreases, the liquid fuel migration rate decreases.

For a solenoid-type actuator, the amount of gaseous fuel delivered may be changed by adjusting the duration of the current supply to the actuator. Increasing the time will increase the amount of gaseous fuel delivered, while decreasing the time will decrease the amount of gaseous fuel delivered. Of course, a solenoid actuator may be designed to operate in an opposite manner like a piezoelectric actuator, and therefore an inverse relationship between the energization duration and the amount of gaseous fuel delivered could apply.

In the event the gas supply is interrupted, an additional check valve in the gaseous fuel passage combined with a liquid fuel bypass passage and a bypass check valve enables liquid fuel to be delivered through both the liquid fuel passage and gaseous fuel passage to the needle valve cavity. This “limp home” feature is advantageous when the gaseous fuel supply is interrupted or unavailable, or during cold starting conditions when the pressure of the gaseous fuel may be insufficient. To reset the bypass valve once gas is re-introduced, the pressure differential may need to be minimized for a period of time to allow gas to begin flowing to the nozzle again.

Finally, it will also be noted that the second fluid, i.e., the gaseous fuel, may also be a second liquid fuel that is supplied at a lower pressure than the pilot liquid fuel. Hence, fuels that are lighter than diesel may be substituted for the gaseous fuel.

It will be appreciated that the foregoing description provides examples of the disclosed apparatus and methods. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A fuel injector for concurrently injecting a liquid fuel and a gaseous fuel into a combustion chamber of an internal combustion engine, the fuel injector comprising:
an injector body having an interior wall defining a cavity, the cavity including a control chamber and an injection chamber, the injection chamber fluidly communicating with an outlet nozzle, and a valve seat disposed between the injection chamber and the outlet nozzle;
a needle valve disposed in the cavity and having a closing surface configured to sealingly engage the valve seat when the needle valve is in a closed position, the needle valve further having a control surface fluidly communicating with the control chamber;
a liquid fuel inlet defined by the injector body and fluidly communicating with the control chamber through a liquid fuel passage;
a gaseous fuel inlet defined by the injector body and fluidly communicating with the injection chamber through a gaseous fuel passage; and
a delivery passage defined by at least one of the needle valve and the interior wall and configured to place the control chamber in fluid communication with the injection chamber, the delivery passage having a cross-sectional area sufficient to permit flow of the liquid fuel.

2. The fuel injector of claim 1, in which the delivery passage comprises a clearance space formed between the needle valve and the interior wall.

3. The fuel injector of claim 2, in which:
the interior wall includes a guide portion disposed between the control chamber and the injection chamber; and
the needle valve includes a stem portion disposed between the control surface and the closing surface, the needle valve stem portion being sized relative to the interior wall guide portion to define the clearance space.

4. The fuel injector of claim 3, in which the needle valve stem portion is cylindrical and defines a first diameter, and the interior wall guide portion is cylindrical and defines a second diameter larger than the first diameter.

5. The fuel injector of claim 4, in which the second diameter is at least 3 microns larger than the first diameter.

6. The fuel injector of claim 1, in which the delivery passage comprises a groove formed in at least one of the needle valve and the interior wall.

7. The fuel injector of claim 1, in which the delivery passage comprises a conduit extending through the needle valve.

8. The fuel injector of claim 1, further comprising a three-way control valve disposed in the liquid fuel passage.

9. A method of operating a fuel injector for concurrently injecting a liquid fuel and a gaseous fuel, the fuel injector including a single needle valve disposed in a fuel injector body, the method including:
supplying a liquid fuel to the fuel injector at a first pressure;
supplying a gaseous fuel to an injection chamber of the fuel injector at a second pressure, the second pressure being less than the first pressure;
directing the liquid fuel to a control chamber operatively coupled to the single needle valve;
migrating the liquid fuel from the control chamber to the injection chamber through a delivery passage defined by at least one of the needle valve and the fuel injector body; and
controlling an amount of liquid fuel migration by adjusting the first pressure.

10. The method of claim 9, in which the delivery passage comprises a clearance space formed between the control chamber and the injection chamber.

11. The method of claim 10, in which:
the fuel injector body includes a guide portion disposed between the control chamber and the injection chamber; and
the needle valve includes a stem portion sized relative to the interior wall guide portion to define the clearance space.

12. The method of claim 11, in which the stem portion is cylindrical and defines a first diameter, and the guide portion is cylindrical and defines a second diameter larger than the first diameter.

13. The method of claim 12, in which the second diameter is at least 3 microns larger than the first diameter.

14. The method of claim 9, in which controlling the first pressure comprises maintaining the first pressure at least 5 MPa higher than the second pressure.

15. The method of claim 9, in which controlling the first pressure comprises maintaining the first pressure approximately 5-20 MPa higher than the second pressure.

16. A fuel injector for concurrently injecting a liquid fuel and a gaseous fuel into a combustion chamber of an internal combustion engine, the fuel injector comprising:
an injector body having an interior wall defining a control chamber and an injection chamber, the injection chamber fluidly communicating with an outlet nozzle, and a valve seat disposed between the injection chamber and the outlet nozzle, the interior wall further including a guide portion disposed between the control chamber and the injection chamber;
a needle valve disposed within the injector body interior wall and having a closing surface configured to sealingly engage the valve seat when the needle valve is in a closed position, the needle valve further having a control surface fluidly communicating with the control chamber and a stem portion disposed between the control surface and the closing surface;
a liquid fuel inlet defined by the injector body and fluidly communicating with the control chamber through a liquid fuel passage;
a control valve disposed in the liquid fuel passage;
a gaseous fuel inlet defined by the injector body and fluidly communicating with the injection chamber through a gaseous fuel passage;
a gaseous fuel check valve disposed in the gaseous fuel passage; and
a delivery passage defined by at least one of the needle valve stem portion and the interior wall guide portion and configured to place the control chamber in fluid communication with the injection chamber, the delivery passage having a cross-sectional area sufficient to permit flow of the liquid fuel.

17. The fuel injector of claim 16, in which the delivery passage comprises a clearance space formed between the needle valve and the interior wall.

18. The fuel injector of claim 17, in which the needle valve stem portion is cylindrical and defines a first diameter, and the interior wall guide portion is cylindrical and defines a second diameter larger than the first diameter, thereby to define the clearance space.

19. The fuel injector of claim 16, in which the delivery passage comprises a groove formed in at least one of the needle valve and the interior wall.

20. The fuel injector of claim 16, in which the delivery passage comprises a conduit extending through the needle valve.
